(19) United States
(12) Patent Application Publication
(10) Pub. No.: US 2011/0117384 A1
(43) Pub. Date: May 19, 2011

(54) Aluminide Barrier Layers and Methods of Making and Using Thereof

(76) Inventors: Samir Biswas, Horseheads, NY (US); Dilip Kumar Chatterjee, Sugar Land, TX (US); Todd Michael Roswech, Ithaca, NY (US)

(21) Appl. No.: 12/992,370

(22) PCT Filed: May 8, 2009
(86) PCT No.: PCT/US09/02869

§ 371 Date: Jan. 26, 2011

Related U.S. Application Data
(60) Provisional application No. 61/127,847, filed on May 16, 2008.

(51) Int. Cl. B32B 15/18; B05D 5/12; B32B 15/00; C25D 5/12; C25D 5/50

(52) U.S. Cl. 428/678; 427/115; 205/181

(57) ABSTRACT

Described herein are methods of producing an aluminide barrier layer, wherein the barrier layer includes nickel aluminide, iron aluminide, or a combination thereof, and the barrier layer is produced by a diffusion coating process on at least one surface of the article. The methods described herein are useful for preventing or reducing the migration of a metal species at or near at least one surface of the article. The articles produced by the methods described herein have numerous applications in the construction and operation of fuel cells.

This application claims the benefit of priority to U.S. Patent Application Ser. No. 61/127,847, filed on May 16, 2008, the content of which is relied upon and incorporated herein by reference in its entirety.

### BACKGROUND

The assembly of fuel cells devices requires metal components. For example, solid oxide fuel cell (SOFC) stacks have metal frames that support solid oxide electrolyte sheet(s). The frames can withstand temperatures in excess of 700° C., thermocycling, and severe oxidizing/reducing environments. An example of a useful metal in fuel cell production is stainless steel. Numerous types of ferritic stainless steels such as AlSl 446, 420, and E-Brite™ are currently used within SOFC stack frames. These steels are favored because they possess optimal thermal expansion ranges, exhibit stability in both oxidizing and reducing environments, and have an operating temperature around 750° C.

Stainless steels, particularly those mentioned above, have a chromium content in the range of 18 to 27 wt. %. When subjected to high temperatures under SOFC stack operating conditions, the chromium may ultimately lead to “cathode poisoning.” In the case of chromium cathode poisoning, chromium present in stainless steel migrates to the surface and is oxidized to Cr(VI) species such as CrO₃ and Cr₂O₂(OH)₂. The Cr(VI) species are subsequently reduced at the cathode to produce Cr₂O₃, which deposits on the surface of the cathode. The deposition of Cr₂O₃ ultimately degrades the performance of the fuel cell over time.

Although chromium poisoning is specific to stainless steel, other metals possess metal species that can form deposits on cathodes in a similar manner. Therefore, there is a need to reduce or prevent the migration and volatilization of metal species present in metals used in fuel cell components that can ultimately form deposits on cathodes and reduce fuel cell efficiency.

### SUMMARY

Described herein are methods of producing an aluminide barrier layer, wherein the barrier layer includes nickel aluminide, iron aluminide, or a combination thereof. The barrier layer is produced by a diffusion coating process on at least one surface of the article. The article is generally a metal component that contains metal species capable of forming metal oxide vapors. The methods described herein are useful for preventing or reducing the migration of a metal species at or near at least one surface of the article. The articles produced by the methods described herein have numerous applications in the construction and operation of fuel cells. The advantages of the invention will be set forth in part in the description which follows, and in part will be obvious from the description, or may be learned by practice of the examples described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several examples described below.

FIG. 1 shows roll cladding of a metal substrate with aluminum foil.

FIG. 2 show roll cladding of a metal substrate with aluminum foil, where a nickel foil is sandwiched between the metal substrate and the aluminum foil.

FIG. 3 shows a cross-section view of SS 446 coupon (1) as coated by Plasma Spraying of Alumina (PSA) and (2) after Cr volatilization testing.

FIG. 4 shows the spalling of a PSA coating after thermal cycling.

FIG. 5 shows the cross-section view SS 446 plated with aluminum and anodized.

FIG. 6 show the burned edges from the anodizing of SS 446 plated with aluminum.

FIGS. 7A and 7B shows anodized SS 446 coupons before and after heat treatment.

FIG. 8 shows the microstructure of SS 446 anodized and heat treated at 800 to 1,000° C.

FIG. 9 shows bare E-Brite after pack aluminizing (marker length is 2 mils).

FIG. 10 shows bare E-Brite after slurry aluminizing (marker length −50 μm).

FIG. 11 shows E-Brite with 12 μm Ni after thermal diffusion.

FIG. 12 shows the BSE image of a slurry aluminized coating prior to oxidation.

FIG. 13 shows EPMA data of a slurry aluminized coating prior to oxidation.

FIG. 14 shows the BSE image of a slurry aluminized coating after oxidation for 48 hours.

FIG. 15 shows the EPMA data of a slurry aluminized coating after oxidation for 48 hours.

FIG. 16 shows the surface XRD of slurry aluminized NiAl oxidized for 48 hours at 800° C.

FIG. 17 shows cross-section views of Ni plated (left) and bare (right) E-Brite (as-coated) produced by out of pack aluminizing.

FIG. 18 shows the surface XRD pattern with peak identification for as-coated E-Brite produced by out of pack aluminizing.

FIG. 19 shows the EPMA analysis of CVD aluminized E-Brite produced by CVD aluminizing.

FIG. 20 shows Al electroplated (40 (μm) E-Brite after thermal treatment at 1000° C.

FIG. 21 shows the EPMA analysis of Al electroplated (40 μm) E-Brite after heat treatment.

FIG. 22 shows an image of aluminum oxide formation on the top layer of Al electroplated E-Brite after heat treatment.

FIG. 23 shows a BSE image of Al electroplated (10 μm) E-Brite after oxidation at elevated temperature for 48 hours.

FIG. 24 shows the EPMA profile of Al electroplated (10 μm) E-Brite after oxidation at elevated temperature for 48 hours.

FIG. 25 shows the delamination of Al and Ni plating on E-Brite, with no delamination observed for Al cladding on 430 SS after heat treatment.

FIG. 26 shows the BSE image of Al clad 430 SS substrate after diffusion and oxidation.

FIG. 27 shows the X-ray mapping of the surface layer indicating the presence of Al₂O₃ and Cr₂O₃ on the surface layer produced by roll cladding and subsequent thermal diffusion and oxidation.

### DETAILED DESCRIPTION

Before the present compounds, compositions, articles, devices, and/or methods are disclosed and described, it is to be understood that the examples described below are not limited to specific compounds, synthetic methods, or uses as such may, of course, vary. It is also to be understood that the terminology used herein is for the purpose of describing particular examples only and is not intended to be limiting.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a metal species” includes mixtures of two or more such species, and the like.

“Optional” or “optionally” means that the subsequently described event or circumstance can or cannot occur, and that the description includes instances where the event or circumstance occurs and instances where it does not. For example, the phrase “optional heating step” means that the heating step may or may not be present.

A weight percent of a component, unless specifically stated to the contrary, is based on the total weight of the formulation or composition in which the component is included.

Described herein are exemplary articles having a barrier layer produced by a diffusion coating process, wherein the layer includes nickel aluminide, iron aluminide, or a combination thereof. The term “barrier layer” is defined herein as the presence of nickel aluminide, iron aluminide, or a combination thereof at the surface of the article to a depth of up to about 150 μm below the surface of the article. In one example, the nickel aluminide, iron aluminide, or combination thereof is present at a depth of 5 μm to 150 μm, 10 μm to 150, μm, 15 μm to 150 μm, 20 μm to 150 μm, 25 μm to 150 or 35 μm to 150 μm from the surface of the article. Using techniques described below, aluminum is applied to the surface of the article under conditions such that the alumina diffuses into the article and below the surface of the article. The aluminum can react with iron and nickel present in the article to produce iron aluminide (e.g., FeAl or Fe₃Al) or nickel aluminide (NiAl or Ni₃Al), respectively. Alternatively, as will be shown below, nickel can be applied to the surface of the article followed by the application of aluminum to produce nickel aluminide.

The amount of aluminum and the depth the aluminum diffuses below the surface can vary depending upon the selection of the diffusion coating technique and the composition of the article. In general, the barrier layer is a gradient of nickel aluminide, iron aluminide, or a combination thereof, where higher amounts of aluminide are at or near the surface of the article and the amount of aluminide gradually decreases as the depth increases. In one example, 10 to 40 atom % aluminum is present relative to the material of the article at a depth of 10 to 20 μm. In another example, 10, 15, 20, 25, 30, 35 or 40 atom % aluminum is present relative to the material of the article at a depth of 10 to 20 μm. Techniques known in the art such as electron probe microanalysis (EPMA) can be used to quantify the amount of aluminum.

The barrier layer can be applied to any metal possessing metal species that can migrate from the metal and form a metal oxide vapor. In one example, the metal can be an iron base alloy, nickel base alloy, or super alloy. An example of iron base alloy includes, but is not limited to stainless steel. Examples of stainless steels include, but are not limited to ferritic stainless steels such as AlSl 446, AlSl 430, and E-Brite™. In one example, the metal article can be any component present in fuel cells such as, for example, a frame for securing an electrode within the fuel cell, a gas inlet tube, or a metal casing. The barrier layer is generally applied to at least one surface of the article. The phrase “at least one surface” is any exposed surface on the article that can receive aluminum. In certain examples, it is desirable to apply the barrier layer to all surfaces of the article, including faces, edges, and the like.

The barrier layer is produced by a diffusion coating process. As described above, the diffusion coating process generally involves the diffusion of aluminum below the surface of the metal so that the aluminum penetrates the metal. In one example, the diffusion coating process includes aluminizing at least one surface of the article to produce nickel aluminide, iron aluminide, or a combination thereof. The term “aluminizing” is defined herein as depositing an aluminum precursor as a vapor on the surface of the article and subsequently heating the aluminum precursor to convert it to aluminum. For example, a volatile aluminum subhalide AlXₙ (X=Cl, F, Br; n<3) is generated during the process and subsequently reacts with the heated surface of the article to deposit aluminum. It is contemplated that the aluminum precursor can penetrate the surface of the article if the article is porous. Because the aluminizing step involves the application of vapor, it is possible to aluminize all exposed surfaces of the article.

In one example, the aluminizing step is performed by pack aluminizing, slurry aluminizing, out of pack aluminizing, or CVD aluminizing. Pack aluminizing includes placing the article to be aluminized inside a pack of aluminum halide vapor producing precursors (e.g. mixture of an aluminum source material such as powdered aluminum and or aluminum chloride, an inert material such as alumina, and an activator such as ammonium chloride) and heating at high temperatures. During pack aluminizing, the aluminum melts, reacts with the halide to form aluminum halide gas, and the gas contacts the surfaces of the article.

Slurry aluminizing includes spraying an aluminum alloy pigment and a halide compound in an organic binder on the article. When the slurry is heated, the halide reacts with aluminum in the alloy pigment to form aluminum-halide vapors. These vapors migrate through the slurry layer to the article where they react to release aluminum. The article is subsequently annealed at high temperatures to diffuse aluminum into the metal surface.

Out of Pack aluminizing includes placing the pack material (aluminum source material, activator, and inert filler, if required) into a special multi-chamber reactor that has gas flow tubes to interconnect the chambers and to provide aluminum gas to the article(s) to be aluminized. The chambers are heated and an aluminum rich gas forms. The remainder of the procedure is identical to pack aluminizing.

CVD aluminizing includes utilizing a gas phase aluminum species to coat an article with a “non-line of sight” process. CVD does not require the use of powders to generate the vapor. CVD aluminizing also permits the coating of internal surfaces of the article having uniform coating thickness.

In one example, prior to aluminizing the article, the article can be coated with a nickel layer. The nickel layer can be applied to the surface of the article using techniques known in the art including, but not limited to, electroplating. In one example, the nickel layer has a thickness of less than 50 μm. In another example, the nickel layer has a thickness from 1 μm to 50 μm, from 1 μm to 40 μm, from 1 μm to 30 μm, from 1 μm to 20 μm, from 2 μm to 20 μm, from 3 μm to 20 μm, or from 4 μm to 20 μm.

In certain examples, after the article has been aluminized, the aluminized article is heated. Not wishing to be bound by theory, it is believed that the heating step facilitates the diffusion of the aluminum into the article. In one example, the article is heated from 800° C. to 1,200° C. for 2 to 8 hours after aluminizing. In other examples, the article is heated from 900° C. to 1100° C. for 4 to 6 hours. In one example, the article is produced by CVD aluminizing the surface of nickel plated stainless steel and heating the article from 900° C. to 1100° C. for 4 to 6 hours.

The heating step can be performed in the absence of air (e.g., an inert atmosphere of nitrogen or argon) to prevent aluminum oxide formation. However, it is contemplated that after heating the article in the absence of air the article can be subjected to additional heating in the presence of air in order to oxidize alumina on the surface of the article to produce aluminum oxide. As will be discussed below, aluminum oxide can also prevent the migration of metal species from the metallic article.

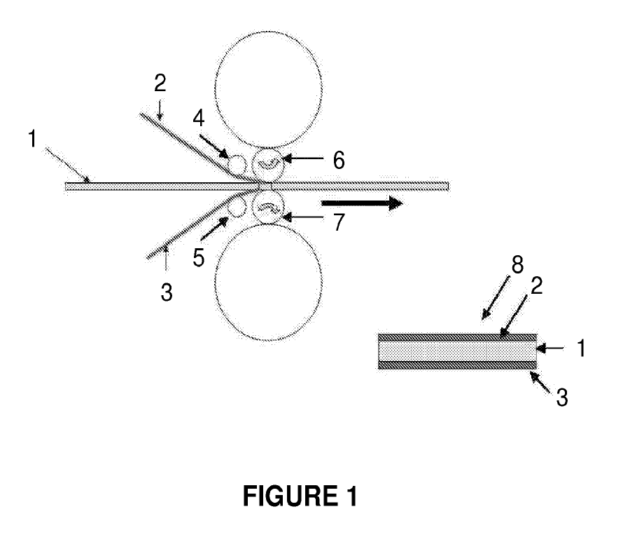

In another example, the diffusion coating process includes roll cladding. In one example, roll cladding includes pressure bonding aluminum foil on at least one surface of the article and heating the article for a sufficient time and temperature to produce a metal aluminide layer on at least one surface of the article. FIG. 1 provides an exemplary embodiment of roll cladding useful herein. Referring to FIG. 1, the article 1 is fed through rollers 4 and 5. As the article is fed through the rollers, aluminum foil 2 and 3 is fed through concurrently. Pressure rollers 6 and 7 compress the aluminum foil to produce a sandwich structure 8. Although FIG. 1 depicts a sandwich structure, it is contemplated that only one side of the article can be pressure bonded with aluminum foil. In one example, the aluminum foil has a thickness of 2 μm to 40 μm, 3 μm to 35 μm, or 5 μm to 30 μm.

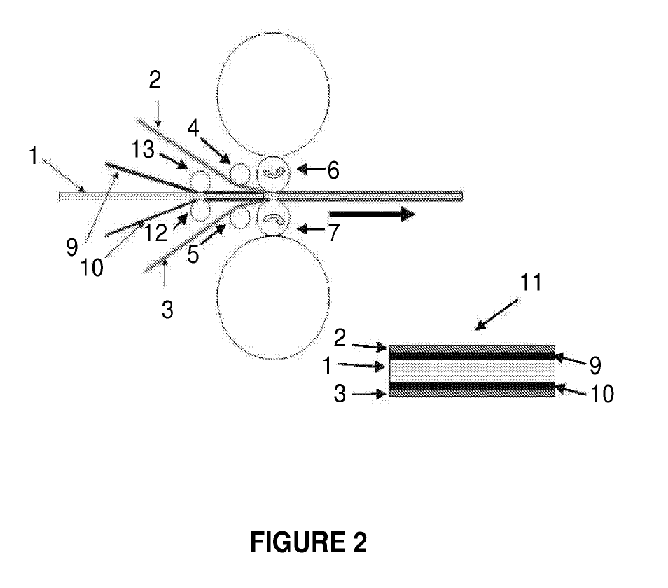

In another example, prior to pressure bonding the aluminum foil on at least one surface of the article, a layer of nickel foil is applied to at least one surface of the article. In one example, the nickel foil has a thickness of 3 μm to 15 μm or 5 μm to 10 μm. In another example, the diffusion coating process includes applying a layer of nickel foil to two surfaces of the component followed by pressure bonding aluminum foil on each exposed surface of each nickel layer. This example is depicted in FIG. 2, where a similar process as shown in FIG. 1 is used with the exception that nickel foil 9 and 10 is applied to two surfaces of the metal substrate 1 by rollers 12 and 13. The multilayered substrate 11 is subsequently produced. After the application of the aluminum foil and optional nickel foil to the article, the article is heated to facilitate the diffusion of aluminum into the article. In one example, the article is heated from 700° C. to 1,200° C. for 1 to 8 hours, or from 700° C. to 1000° C. for 2 to 4 hours.

In another example, the diffusion coating process includes (1) electroplating nickel on at least one surface of the article to produce a nickel layer; (2) electroplating aluminum on the nickel layer to produce an aluminum layer, and (3) heating the article for a sufficient time and temperature to produce a metal aluminide layer. Techniques for electroplating metallic surfaces known in the art can be used herein. In one example, the nickel layer has a thickness from 0.5 to 5 μm and the aluminum layer has a thickness from 5 to 30 μm. In another example, the nickel layer has a thickness from 1 to 5 μm and the aluminum layer has a thickness from 10 to 25 μm. After the article has been electroplated with nickel and aluminum, the article is heated to facilitate thermal diffusion of the aluminum into the article and produce the aluminide barrier layer. In one example, the electroplated article is heated from 700° C. to 1,200° C. for 1 to 8 hours or from 700° C. to 1000° C. for 2 to 4 hours.

Heat treatment of the articles discussed above is generally conducted in an inert atmosphere. However, in certain examples, after heat treatment in an inert atmosphere, the article can be further heated in the presence of oxygen to oxidize some of the aluminide to aluminum oxide. Not wishing to be bound by theory, metal species such as, for example, chromium, behaves as an oxygen scavenger and forms a Cr₂O₃ scale layer. The low oxygen potential resulting at the Cr₂O₃/alloy interface allows for the formation of a dense and continuous inner layer of Al₂O₃. The aluminum oxide layer formed at the surface of the article and at the interface of the aluminide barrier layer can further prevent the migration of metal species to the surface of the article.

The methods described herein are useful for preventing or reducing the migration of a metal species present in an article at or near at least one surface of the article. A metal species is any volatile elemental metal present in the article that can rapidly migrate to the surface of the article and becomes oxidized in the presence of oxygen. The metal species can vary depending upon the selection of the metal used to produce the article. For example, chromium is a metal species present in stainless steel. Other examples of metal species include, but are not limited to, tungsten, molybdenum, silicon, and magnesium. The ability of the aluminide barrier layer to retain the metal species can be measured using techniques known in the art (see Table 5 of the Examples). In one example, the barrier layer can retain greater than 90% or greater than 95% of the metal species within the metal article.

### EXPERIMENTAL

The present invention will now be described with specific reference to various examples. The following examples are not intended to be limiting of the invention and are rather provided as exemplary embodiments.

### I. Preparation and Characterization of Coated Articles

A. Thermal and Plasma Spray

Thermal and plasma spraying involve processes in which metallic and nonmetallic materials are deposited in a molten or semi-molten state on a prepared substrate imparting properties that the substrate would not otherwise possess. In these methods, either an electric or gas source (for thermal spray) or plasma sources (for plasma spray) is used to melt the alumina powder feedstock. As the molten powder particles impinge with high velocities on a ferritic stainless steel substrate or on a SOFC frame, they form a dense coating of oxides (alumina, zirconia or other mixed oxides) on the steel surface. Plasma spraying of alumina and other oxides (zirconia or spinel) on a number of ferritic stainless steels coupons and SOFC frames was investigated, and the results are presented below.

The Plasma Spraying of Alumina (PSA) process was carried out using a SG-100 gun at 40-42 volts of power and 800 amps of current. A mixture of argon and helium gases was ionized to generate the plasma.

Pre-Treatment of Parts to be Plasma Sprayed:

a. Parts were placed in an ultra-sonic acetone bath for a 3-5 minute soak.
b. Parts were placed in a dryer at 105° C. for 10-15 minutes.
c. Parts were masked (if required) and Al₂O₃ grit blasted.
d. Surface finish measurements are taken to insure blasted surface finish is (Arithmetic average roughness) Ra 6.35 μm (minimum).
e. Parts were placed in an ultra-sonic acetone bath for a 3-5 minute soak.
f. Parts were placed in a dryer at 105° C. for 10-15 minutes.

Bond Coat (if Required):

For some of the Plasma Spraying of Alumina (PSA) coating runs that were applied to steels, a bond coat layer was deposited first on cleaned substrates by a plasma spray process for good adherence. For example, NiCrAlY alloy is known to be most suitable as a bond coat material and is applied by plasma spraying on the cleaned parts at a thickness of about 50 μm±25 μm (2±1 mils).

Top Coat of Al₂O₃:

a. O₃ powder was used for application of 162.5±37.5 μm (3.5±1.5 mils) PSA coating;
b. overall thickness measurements were taken using a magnetic induction thickness tester.

Both SS 446 and E-Brite coupons were coated with 6 mil thick alumina and were used for investigation of Cr volatilization rate.

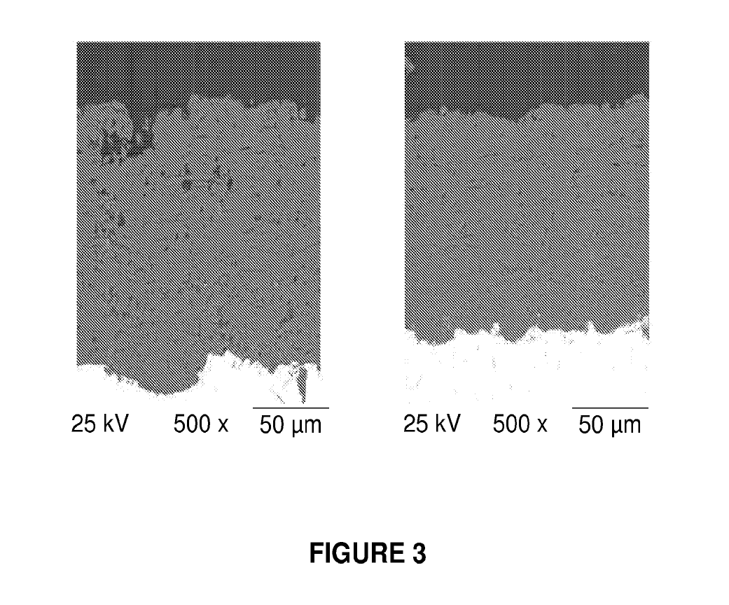

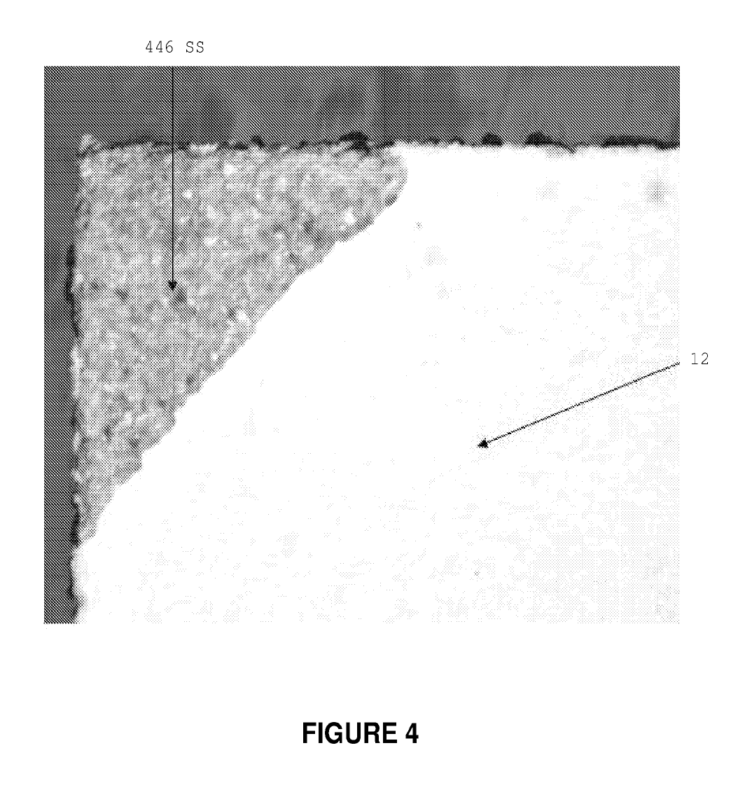

Typical cross sections of SS 446 coupons in as-coated and after the Cr volatilization test are shown in FIG. 3. Alumina coating appears to have become slightly denser when subjected to heating at 800° C. during the Cr volatilization test. No evidence of spalling was observed after the Cr volatilization test (FIG. 3). However, spalling was observed occasionally after thermal cycling to 750° C. from room temperature (RT) when repeated 3 times in a separate test (FIG. 4).

B Anodizing of Electroplated Aluminum on Ferritic Stainless Steel

Anodizing of electroplated aluminum is a method where aluminum film is electroplated on ferritic stainless steels and the electroplated films were either partially or fully converted to alumina (Al₂O₃) by anodizing. Since electrodeposited aluminum film has poor adhesion on steel, a thin layer (about 2 to 3 μm) of nickel was plated first on the steels by standard electroless processes, which served as the adhesion layer.

Three different materials were evaluated:

1. electro deposition of pure Ni from sulphamate bath or electroless deposition of Ni using mid phosphorus bath (2-4 μm thickness);
2. electro deposition of Al (15-40 μm thickness); and
3. anodizing to convert electroplated Al to form alumina film (60-95% conversion)

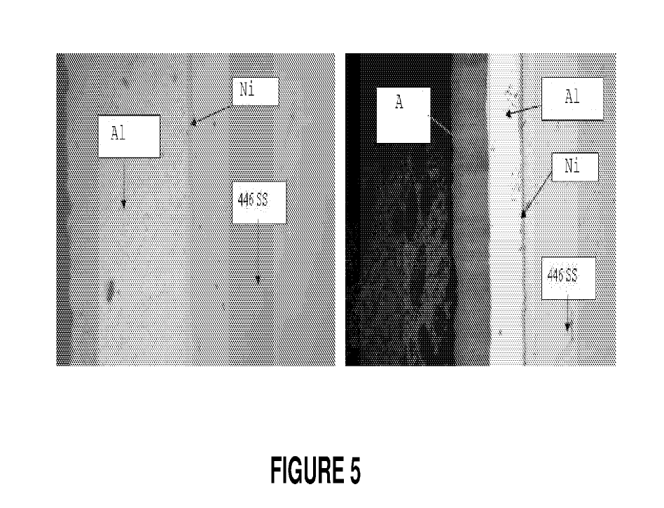

A Ni sub-layer was applied to the surface prior to anodizing. The industrial practice of plating Al on steel was followed. A thin (about 2 μm) layer of electroless or electrodeposited nickel was applied on the steel prior to aluminum electroplating. In earlier experiments using SS 446 coupons, Al plating thickness was specified at around 30-40 μm. The Al layer was then anodized to different conversion levels (60-90%) forming an adonized layer A (FIG. 5).

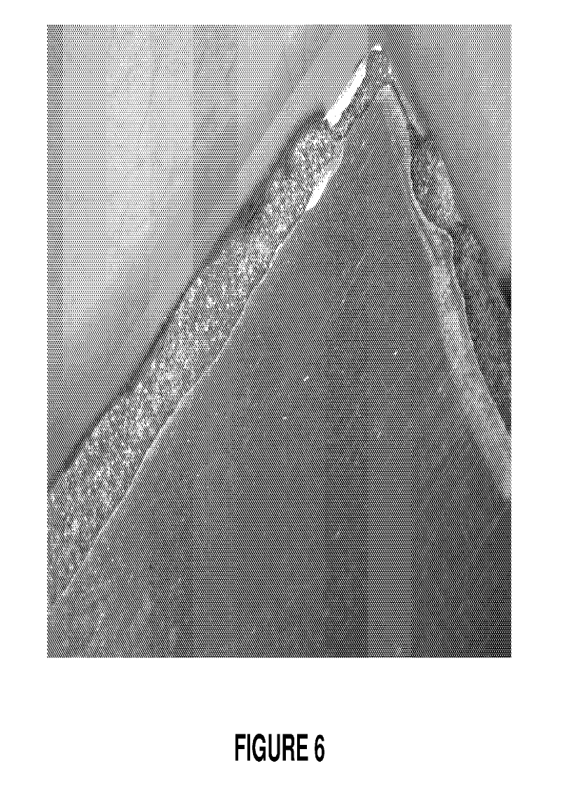

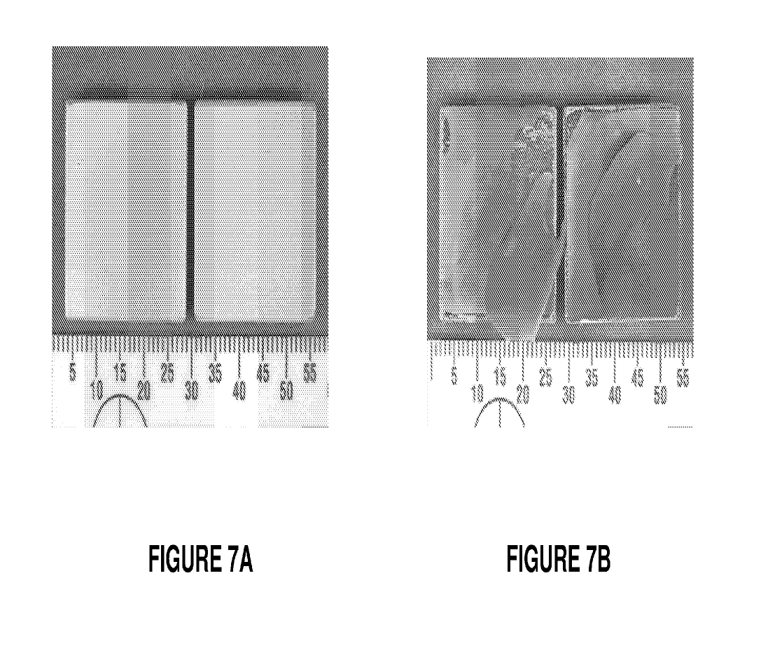

In order to avoid burn-out issues (FIG. 6) when approaching high conversion (90%), it is preferable for some residual Al to remain on the surface. During subsequent heat treatment of the anodized coupons at 800-1000° C., some exfoliation of the anodized layer was observed (see FIGS. 7A and 7B).

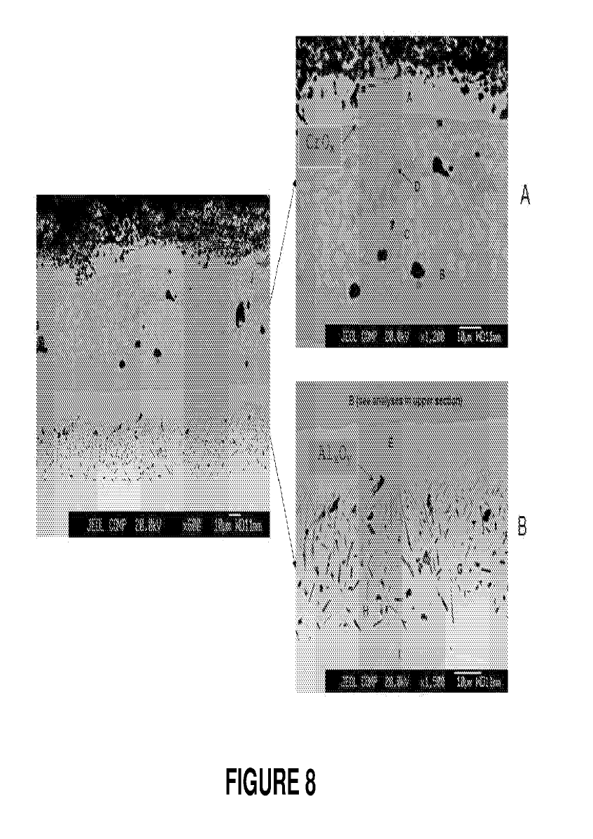

During heat treatment of the coupon, residual Al diffused into the substrate to alloy with different elements of the stainless steel and form a complex microstructure composed of different types of aluminides (FIG. 8 and Table 1). The presence of acicular (needle shaped) precipitates, identified as AlN (Table 2), in the inter-diffusion zone (Zone B) was also observed due to the high nitrogen content (0.25 wt. % max) in SS 446 grade ferritic stainless steel, which may promote spallation of brittle intermetallic as-deposited coatings in high N containing (790 ppmw) commercial 304 L stainless steel.

TABLE 1
EPMA data - Different Phases in Diffusion Zone

at %

| Phase | Al | Fe | Cr | Mn | Ni | Total |
|---|---|---|---|---|---|---|
| A | 50.43 | 30.67 | 7.82 | 0.31 | 10.78 | 100.00 |
| B | 56.78 | 29.93 | 12.80 | 0.43 | 0.06 | 100.00 |
| C | 49.02 | 41.38 | 7.67 | 0.38 | 1.55 | 100.00 |
| D | 62.48 | 29.96 | 6.86 | 0.22 | 0.49 | 100.00 |
| D | 63.54 | 30.86 | 5.07 | 0.18 | 0.35 | 100.00 |

TABLE 2
EPMA Data - Different Phases in Inter-diffusion Zone

| | at % | | | | | | |
|---|---|---|---|---|---|---|---|
| Phase | Al | Fe | Cr | Mn | Ni | N | Total |
| E | 48.39 | 41.68 | 9.08 | 0.43 | 0.41 | n.a. | 100.00 |
| F | 32.08 | 44.61 | 22.63 | 0.45 | 0.23 | n.a. | 100.00 |
| G | 26.26 | 49.75 | 23.29 | 0.49 | 0.21 | n.a. | 100.00 |
| H | 10.88 | 63.32 | 24.99 | 0.61 | 0.21 | n.a. | 100.00 |
| I (Base Metal) | 0.05 | 72.17 | 26.75 | 0.72 | 0.30 | n.a. | 100.00 |
| Acicular | 40.84 | 6.15 | 3.13 | 0.09 | 0.02 | 49.76 | 100.00 |
| Acicular | 38.76 | 8.18 | 4.05 | 0.10 | 0.03 | 48.90 | 100.00 |

C. Diffusion Coatings Processes

Pack Aluminizing

Pack aluminizing of SS 446 substrate was carried out under the following conditions:

### Condition 1:

| | |
|---|---|
| DIFFUSION TEMP. (AVG.): 1669° F. | DIFFUSION TIME: |
| (909.4° C.) | 20 hours |
| AVG. DIFFUSION DEPTH: 0.0060 inches | =150 μm (6.0 mils) |
| | C |

### Condition 2:

| | |
|---|---|
| DIFFUSION TEMP. (AVG.): 1820° F. | DIFFUSION TIME: |
| (993.3° C.) | 20 hours |
| AVG. DIFFUSION DEPTH: 0.0074 inches | =185 μm (7.4 mils) |
| | C |

### Condition 3:

| | |
|---|---|
| DIFFUSION TEMP. (AVG.): 1589° F. | DIFFUSION TIME: |
| (865° C.) | 6 hours |
| AVG. DIFFUSION DEPTH: 0.0006 inches | =15 μm (0.6 mils) |
| | C |

### Condition 4:

| | |
|---|---|
| DIFFUSION TEMP. (AVG.): 1628° F. | DIFFUSION TIME: |
| (886.6° C.) | 6 hours |
| AVG. DIFFUSION DEPTH: 0.0015 inches | =37.5 μm (1.5 mils) |

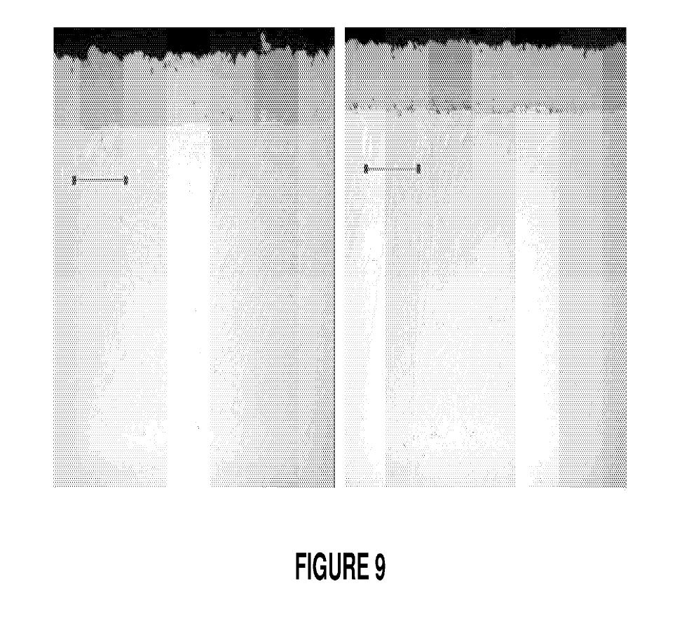

E-Brite substrate was used for pack aluminizing in later trials. Bare E-Brite substrates were pack aluminized using low temperature (LT) and high temperature (HT) processes. The aluminide layer formed in the LT process is about 1 mil thick, and the aluminide layer formed in the HT process was about 1.4 mils thick. Evidence of grain growth of E-Brite substrate during HT pack aluminizing was also observed (FIG. 9).

Slurry Aluminizing (Vapor Phase)

In the first trial, coupons of bare as well as Ni plated E-Brite and SS 446 were coated using two different formulations of slurry (high and low activity). In a low activity aluminizing process, conditions are suitable for outward growth of aluminide coating by diffusion of substrate elements (Fe, Ni) to the surface where they combine with Al, which means that Al inward diffusion rate is slower than the outward diffusion rate of substrate elements. This process will produce aluminide with higher Al content (FeAI, NiAl). Conversely, in a high activity aluminizing process, the inward diffusion rate of Al is higher than that of outward diffusion rate of substrate elements. As a result, aluminides of lower Al content would form (Fe₃Al, Ni₃Al). Test matrix is shown in Table 3. For both processes A and B, the aluminum was deposited at 980° C. for 2 hours under argon and then diffused under a vacuum at 1,080° C. for 2 hours and aged at 800° C. for 4 hours.

TABLE 3

| Process/Materials | High Activity | Low Activity |
|---|---|---|
| SS 446 bare | ✓ | ✓ |
| SS 446, 6 μm Ni | ✓ | ✓ |
| E-Brite bare | ✓ | ✓ |
| E-Brite, 6 μm Ni | ✓ | ✓ |
| E-Brite, 12 μm | ✓ | ✓ |

The low activity slurry aluminizing of E-Brite™ substrates is preferable to use of SS 446 substrates, because better quality coatings were achieved. Thus, the low activity slurry aluminizing of E-Brite™ substrates were further investigated in detail.

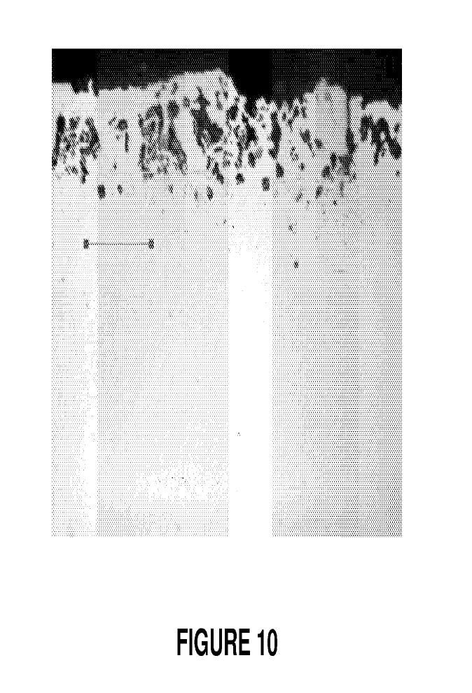

Bare E-Brite substrate was slurry coated and followed by diffusion treatment under a vacuum at 1,080° C. for 2 hours and aged at 800° C. for 4 hours (FIG. 10).

Slurry aluminizing was performed using 12 μm Ni plated E-Brite substrate only. Before application of the slurry coating, Ni plated substrates were vacuum annealed at 950° C. for 1 hour.

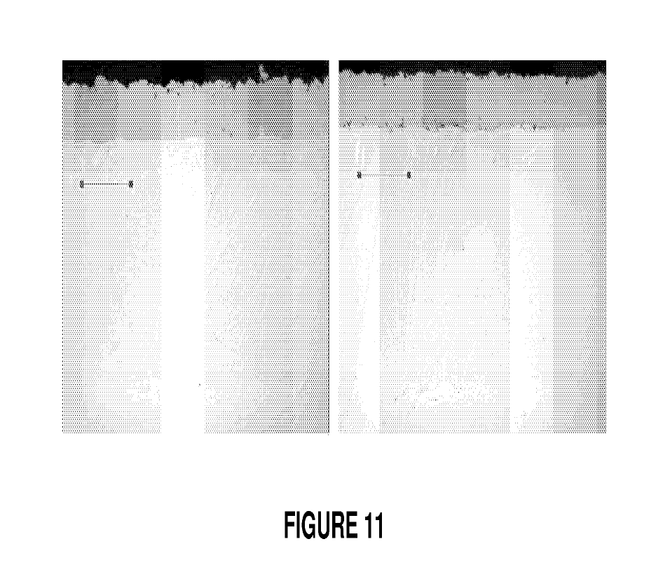

The aluminide averaged 1.3 mils in thickness (FIG. 11). Side 2 of the sample has some small voids under the aluminide however there are no large voids/porosity as seen in coupons from other processes as discussed in the previous section. The interface on side 1 of the sample did not show any porosity.

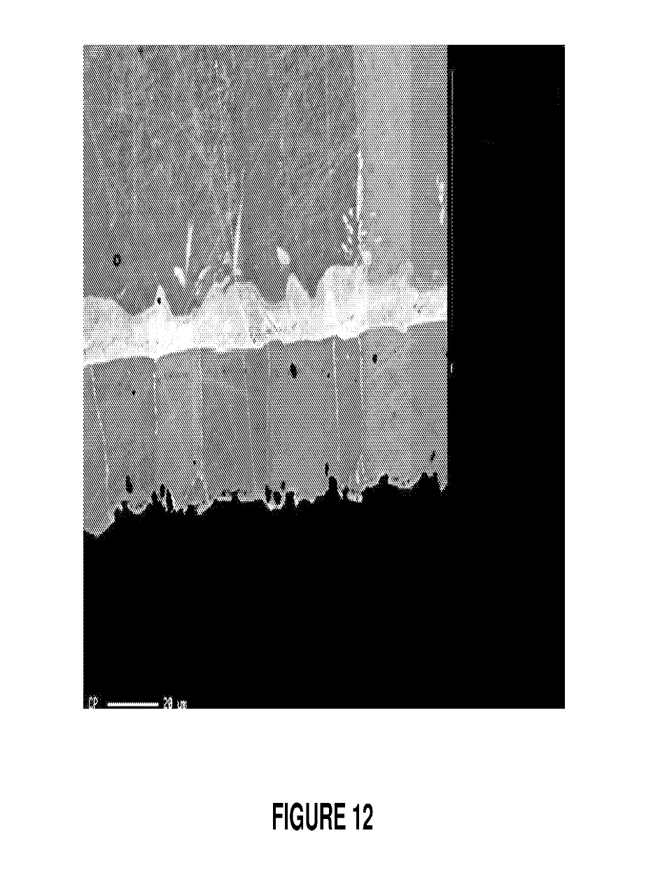

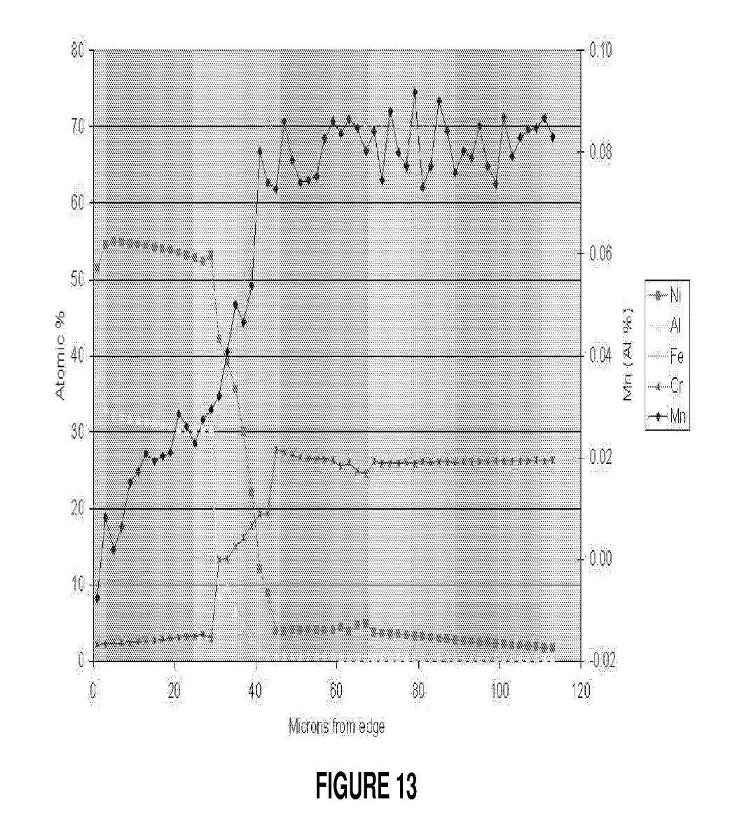

EPMA and X-ray diffraction analyses were performed to characterize the phases formed in as-coated condition and after oxidation treatment of coupons at 800° C. (FIG. 12). As-coated samples, which were aged at 800° C. for 4 hours, showed very low levels of Cr up to 30 μm depth of the coating layer (FIG. 13), indicating that the aluminide coating layer is an effective barrier layer to Cr migration (see Table 5). In addition, it was expected that the aluminide coating when oxidized would produce a thin aluminum oxide layer on the top surface that might further reinforce the Cr barrier properties of the intermetallic coating.

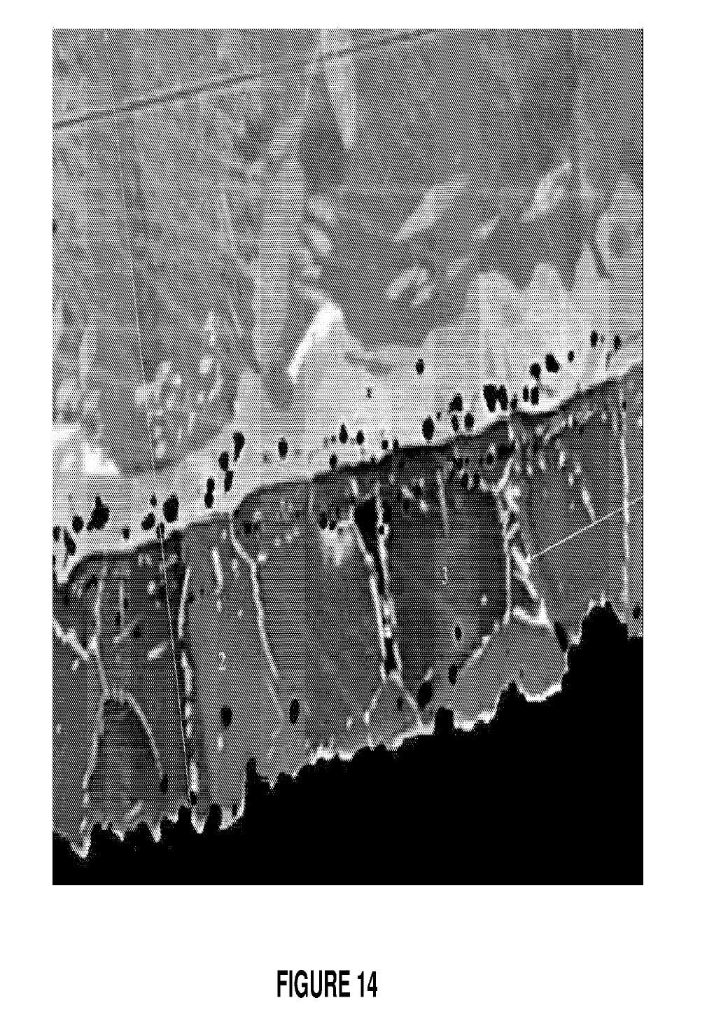

Therefore, aluminide coated coupons were further oxidized for 48 hours at 800° C. Microscopic observations revealed that the voids at the coating/substrate interface became more abundant after oxidation (FIG. 14). Table 5A below shows compositions measured at four different point locations.

TABLE 5A

| | Wt % | | | | | | Atomic % | | | | | |
|---|---|---|---|---|---|---|---|---|---|---|---|---|
| Pt. # | Mn | Ni | Al | Fe | Cr | Total | Mn | Ni | Al | Fe | Cr | Total |
| 1 | 0.10 | 3.52 | 0.15 | 61.45 | 33.77 | 98.99 | 0.10 | 3.30 | 0.31 | 60.55 | 35.74 | 100.00 |
| 2 | 0.02 | 68.28 | 19.54 | 13.05 | 2.20 | 103.09 | 0.02 | 53.76 | 33.47 | 10.80 | 1.96 | 100.00 |
| 3 | 0.02 | 67.37 | 18.72 | 13.70 | 2.82 | 102.63 | 0.02 | 53.59 | 32.40 | 11.45 | 2.54 | 100.00 |
| 4 | 0.11 | 9.86 | 0.35 | 75.42 | 17.90 | 103.63 | 0.10 | 8.95 | 0.69 | 71.93 | 18.34 | 100.00 |

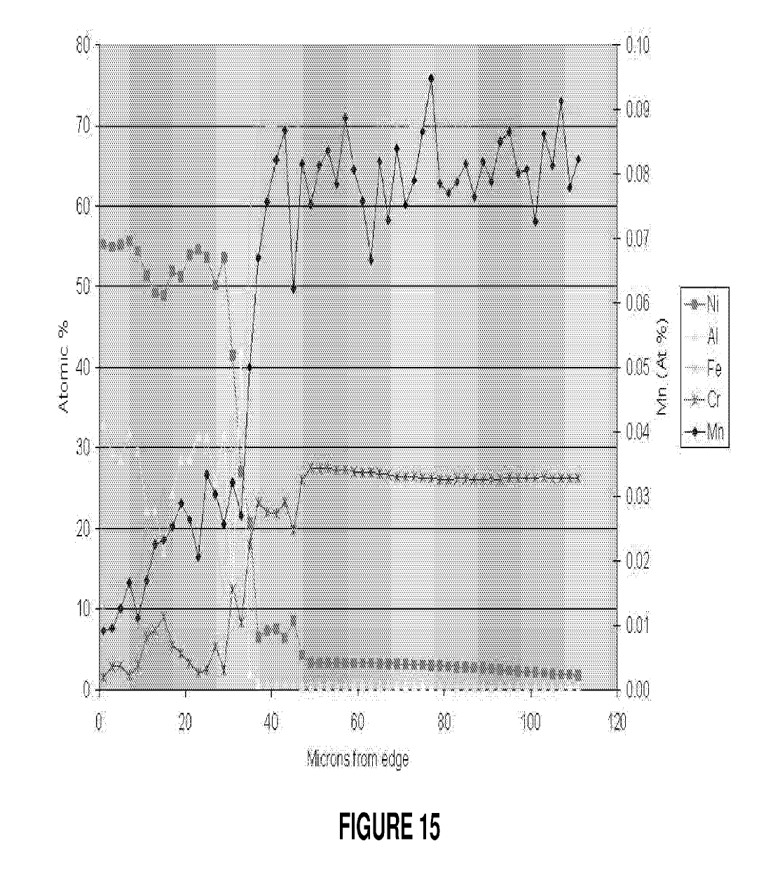

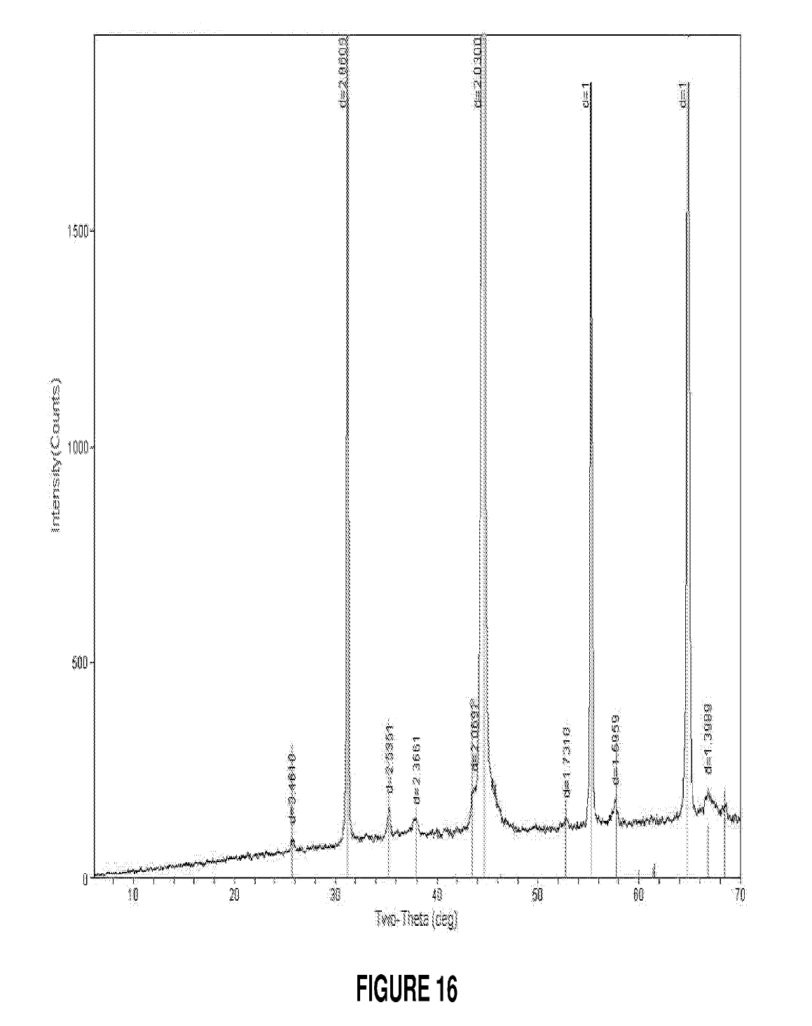

The compositions of different phases and EPMA profile after oxidation are shown in FIGS. 14 and 15. The EPMA data shows that there is an elevated level of Cr in the coating layer after oxidation at 800° C., meaning that there may be instances of the Cr diffusion through the coating (FIG. 15). Surface X-ray diffraction of the oxidized sample (FIG. 16) identified the presence of NiAl and a very low level of α-Al₂O₃.

Out of Pack Aluminizing (Vapor Phase)

Only E-Brite substrates, both bare and Ni plated, were considered for vapor phase (out of pack) aluminizing process. The Ni plating thickness was chosen at about 12 μm. Prior to aluminizing, Ni plated coupons were vacuum annealed at 950° C. for 1 hour to improve adhesion of the Ni layer to the substrate.

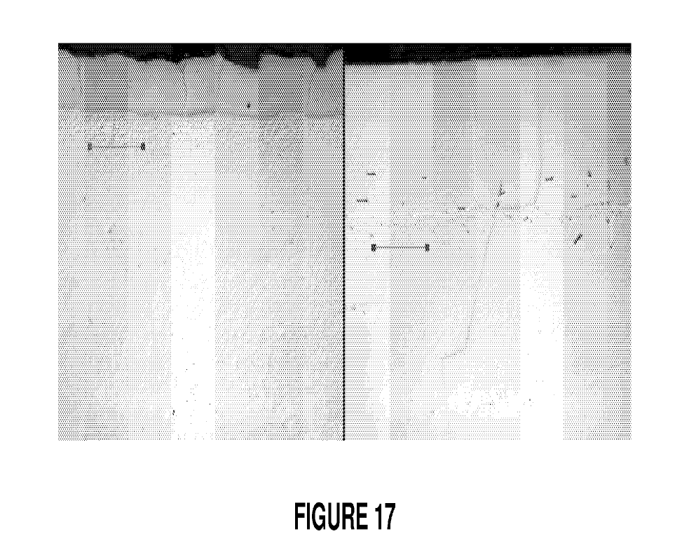

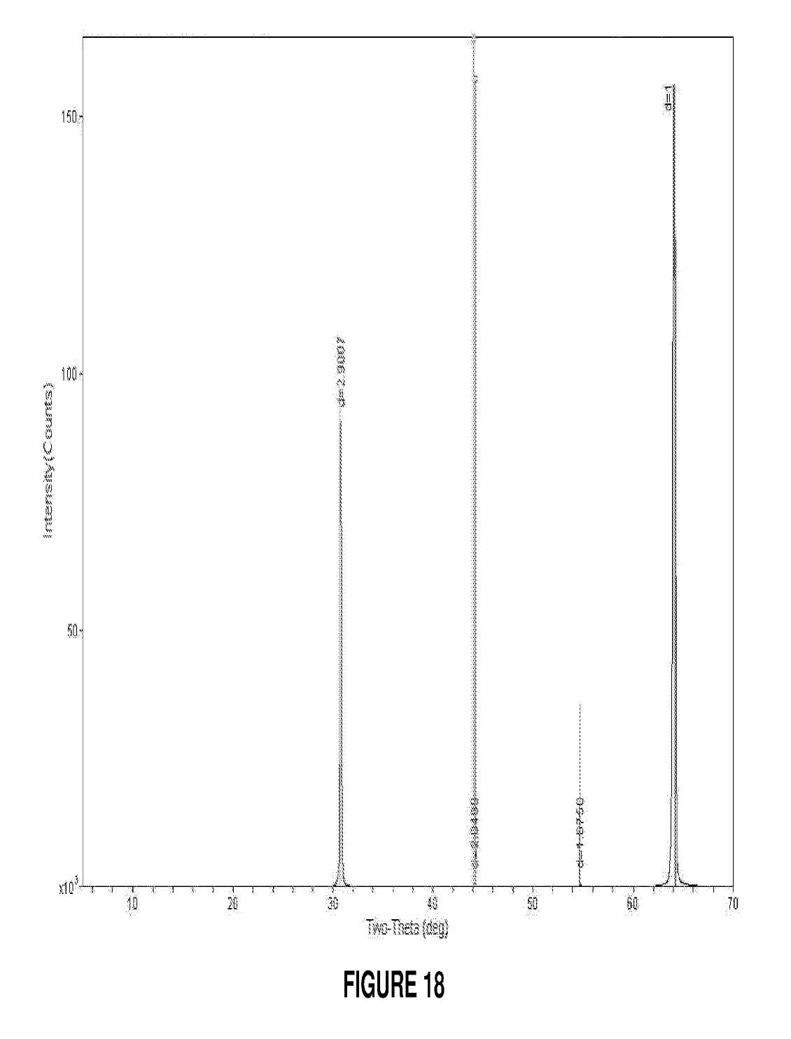

Both Ni plated as well as bare E-Brite substrates were aluminized using this process. The coating thickness for Ni plated E-Brite was around 1.2 mils, while that for the bare substrate was about 3 mils (FIG. 17). FIG. 18 shows the surface XRD pattern with peak identification for as-coated VPA E-Brite. After comparing with the diffraction pattern of uncoated E-Brite, the coating phase was determined to be most likely FeAl. Surface X ray diffraction of oxidized VPA coated E-Brite, bare or Ni plated, failed to detect presence of any a alumina, which is likely due to low oxidation temperature (800° C.) as discussed earlier.

CVD Aluminizing

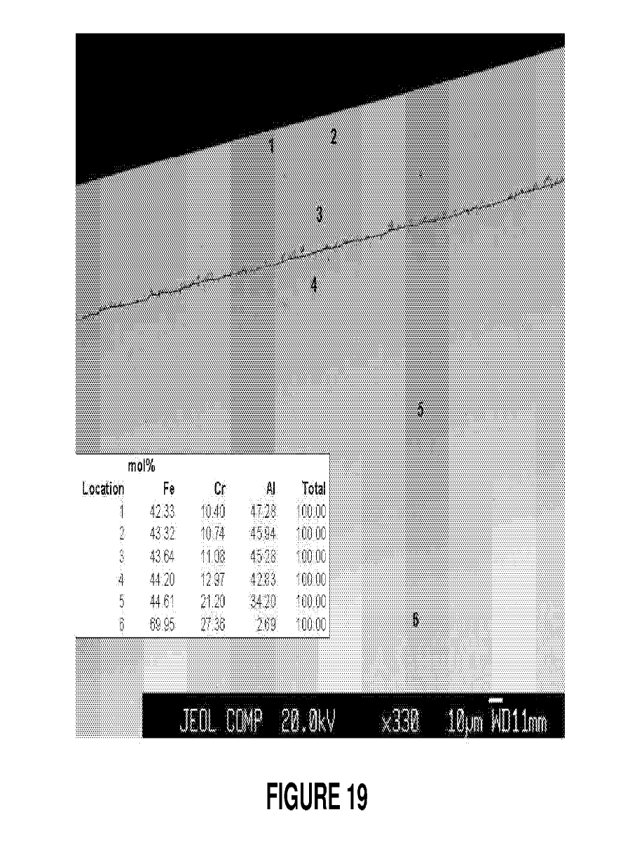

CVD aluminized E-Brite had an outer layer composition composed of FeAl intermetallic phase with about 10 atom % chromium solubility in the intermetallic (FIG. 19). FeAl phase extends up to about 60 μm towards the interior of the steel substrates from the outer surfaces. The predominance of the cracks extending from the outer layer to the interior of the substrates or voids at the substrate/coating interface was much less common in CVD aluminized samples compared to samples from other diffusion coating processes.

Aluminum Plating and Thermal Diffusion

To improve adhesion of Al to stainless steel, a thin layer of Ni was applied between the stainless steel substrate and the electroplated Al. The ratio of Al to Ni thickness can be altered to achieve surface alloying with different chemistry and structure after thermal diffusion at 950° C. to 1000° C. (Table 4).

TABLE 4

| | | | | Target Coating |
|---|---|---|---|---|
| Substrate | Ni plating thickness | | Al plating thickness | Type |
| E-Brite | 2 | μm | 40 μm | Fe-aluminide |
| E-Brite | 6 and 12 | μm | 10 μm | Ni-aluminide |

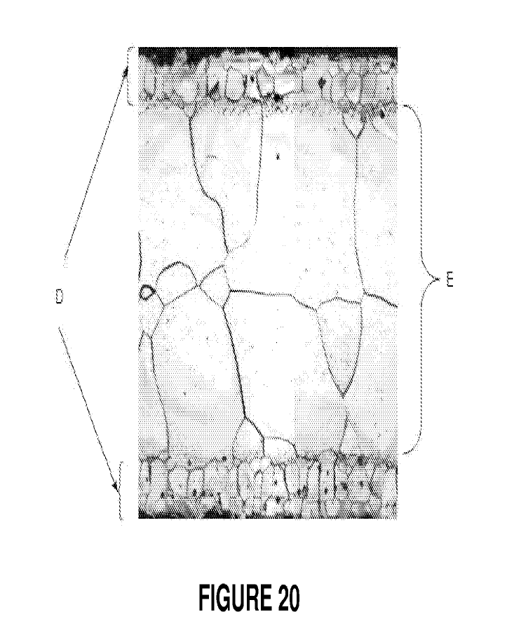

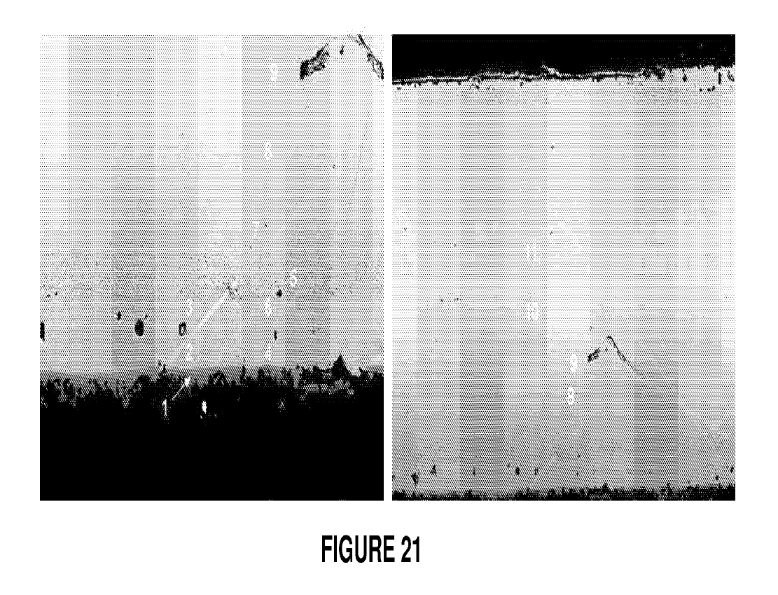

Experiments were done with varying ratios of aluminum to nickel plating thickness (Table 4) in order to form iron aluminide or nickel aluminide coatings after heat treatment. With Al plating of 40 μm and Ni plating of 2 μm thickness, the surface layer formed was rich in iron and aluminum with some Cr and Ni in solution (FIGS. 20 & 21). It is evident that there was significant grain growth in the E-Brite substrate during heat treatment at 1,000° C. (FIG. 21). Table 4A shows chemical compositions measured at 11 different locations of the surface layer of FIG. 21. Table 4B shows chemical compositions measured at 11 different locations of the surface layer of FIG. 21.

TABLE 4A

| | Wt % | | | | |
|---|---|---|---|---|---|
| # | Al | Fe | Cr | Ni | Total |
| 1 | 18.47 | 49.55 | 9.54 | 22.72 | 100.28 |
| 2 | 10.46 | 65.77 | 18.83 | 4.38 | 99.44 |
| 3 | 9.53 | 66.70 | 21.03 | 2.75 | 100.01 |
| 4 | 10.91 | 65.01 | 18.73 | 5.15 | 99.80 |
| 5 | 9.44 | 66.69 | 21.04 | 2.68 | 99.85 |
| 6 | 9.16 | 66.34 | 21.82 | 2.00 | 99.32 |
| 7 | 8.04 | 66.64 | 23.26 | 1.00 | 98.94 |
| 8 | 6.27 | 68.48 | 24.72 | 0.31 | 99.78 |
| 9 | 4.33 | 69.92 | 25.29 | 0.12 | 99.36 |
| 10 | 1.32 | 71.77 | 25.92 | 0.10 | 99.11 |
| 11 | 0.70 | 71.91 | 25.81 | 0.15 | 98.57 |

TABLE 4B

| | mol % | | | | |
|---|---|---|---|---|---|
| # | Al | Fe | Cr | Ni | Total |
| 1 | 31.96 | 41.41 | 8.56 | 18.07 | 100.00 |
| 2 | 19.36 | 58.82 | 18.09 | 3.73 | 100.00 |
| 3 | 17.67 | 59.75 | 20.23 | 2.34 | 100.00 |
| 4 | 20.05 | 57.73 | 17.87 | 4.35 | 100.00 |
| 5 | 17.54 | 59.88 | 20.29 | 2.29 | 100.00 |
| 6 | 17.14 | 59.96 | 21.18 | 1.72 | 100.00 |
| 7 | 15.24 | 61.02 | 22.88 | 0.87 | 100.00 |
| 8 | 11.98 | 63.23 | 24.52 | 0.27 | 100.00 |
| 9 | 8.47 | 65.77 | 25.66 | 0.11 | 100.00 |
| 10 | 2.67 | 70.06 | 27.18 | 0.10 | 100.00 |
| 11 | 1.43 | 71.04 | 27.39 | 0.14 | 100.00 |

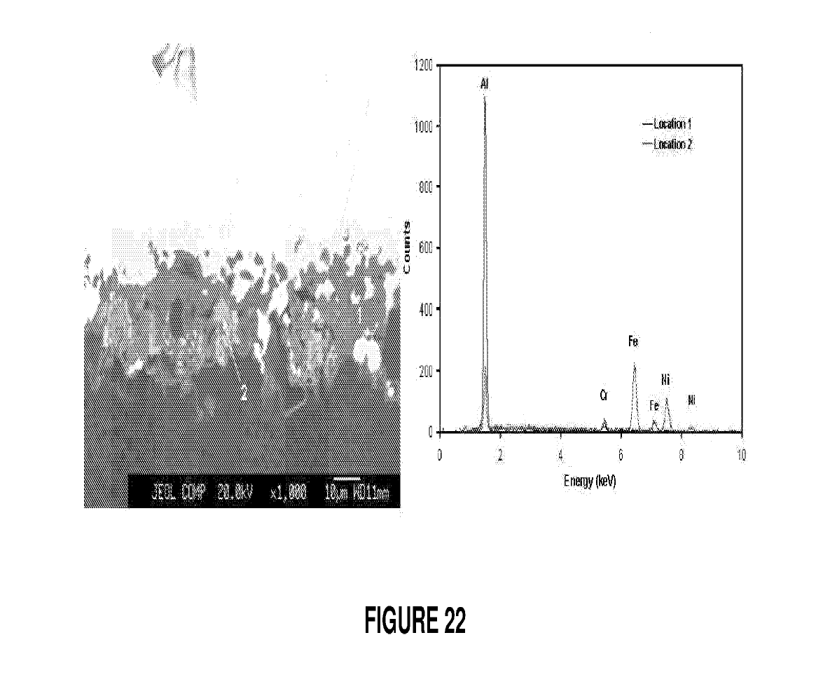

The detailed EPMA analyses of the sample after heat treatment are shown in FIG. 21. The intermetallic layer formed in this case has up to 20 wt % Cr (FIG. 21—location 3) in solution. Most likely this high level of Cr and the higher heat treatment temperature of 1,000° C. helped with the formation of oxide layer on the top surface. The oxide consisted mainly of alumina with a small amount of mixed oxide (FIG. 22).

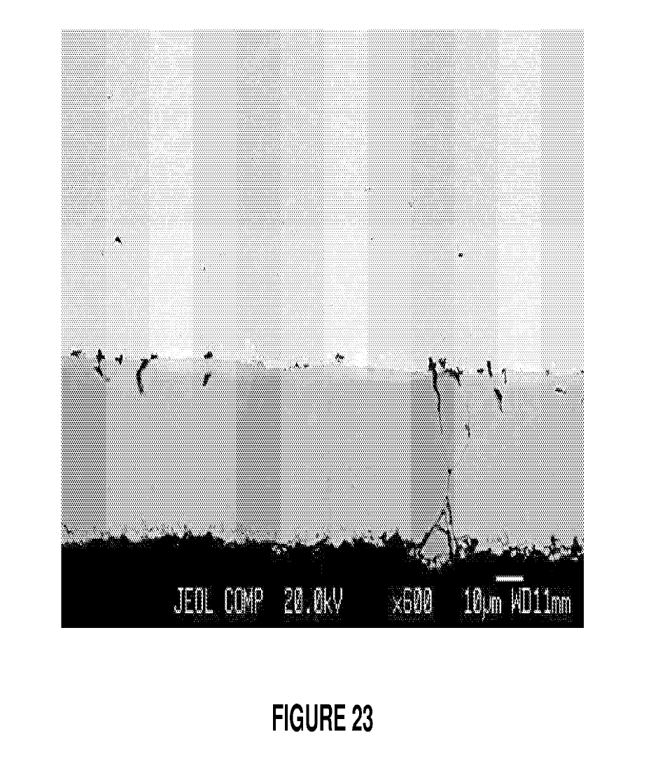

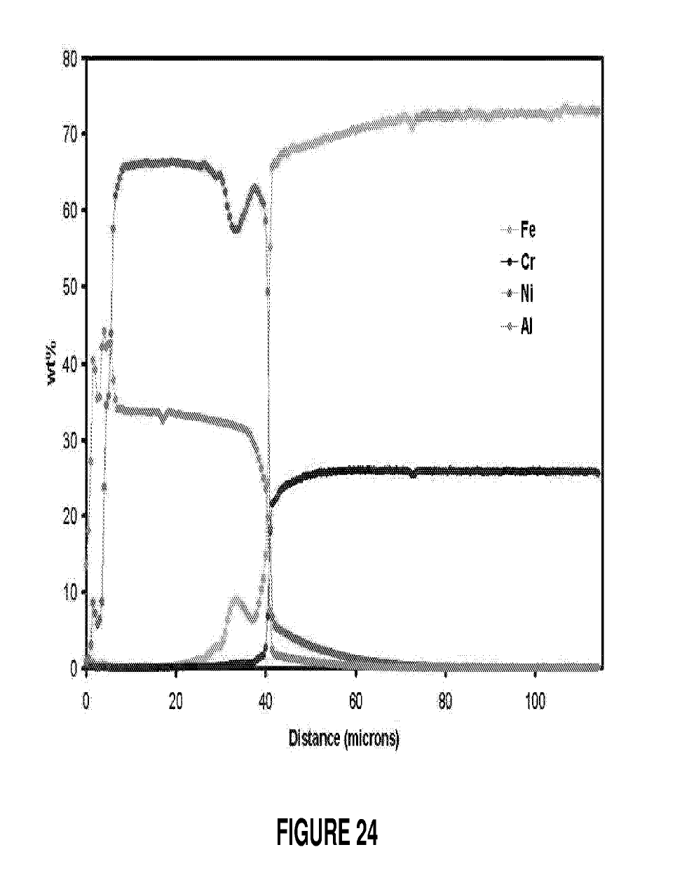

When Ni plating thickness was increased to 12 μm and Al plating thickness was decreased to 10 μm, the first 30 μm of the coating layer formed was mostly NiAl type aluminide (FIGS. 23 and 24). Very little Cr uptake in NiAl layer (FIG. 24) even after 48 hours oxidation at 800° C. was observed. That is, this process resulted in good prevention of Cr₂O₃ deposit formation. Although some cracking of the coating layer (NiAl layer) was observed (FIG. 23) this proves that the NiAl coating can successfully function as a Cr barrier layer (see Table 5).

Roll Cladding and Thermal Diffusion

This process was investigated using SS 430 with Al cladding on both sides of the substrate (FIG. 1). The laminated structure was manufactured by roll cladding using 40 μm thick pure Al (AA1145) bonded to both sides of SS 430 substrate to produce a final laminate thickness of 0.381 mm. The material was supplied in ½ H temper condition to retain some formability for stamping and light bending operation, if required, before final thermal diffusion treatment.

Thermal diffusion treatment of coupons with electroplated Al on Ni plated E-Brite substrate and Al clad 430 SS was performed using the following procedure:

1. Place coupons inside a tube furnace and cap both ends;
2. 1^{st} Stage—Flow Argon at RT for 2 hours;
3. Then raise furnace temperature to 950° C., while Argon supply is ON;
4. Hold at this temperature for 2 hours, while Argon supply is ON;
5. At the end of this stage, shut off the Argon supply and switch to air from cylinder;
6. Adjust the furnace temperature to 800° C. while air supply is ON;
7. Hold at 800° C. for 48 hours while air supply is ON; and
8. At the end of the hold period, shut off the furnace power as well as the air supply.

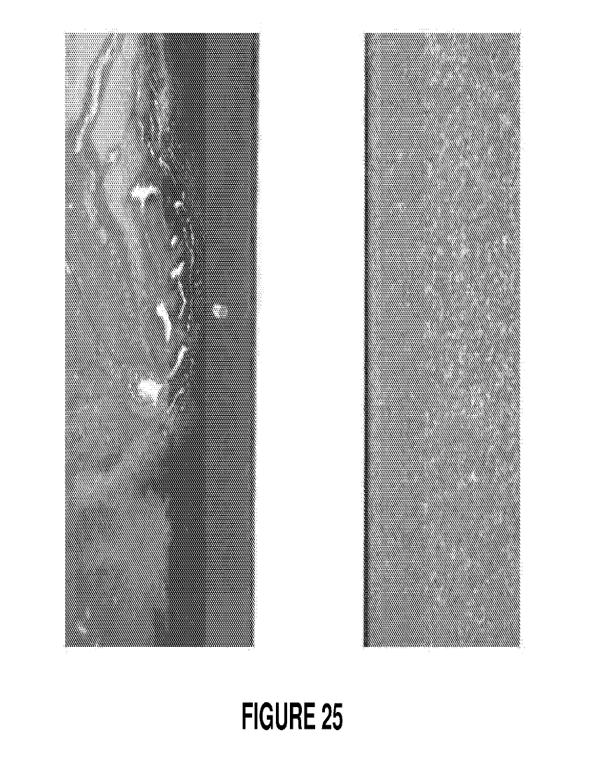

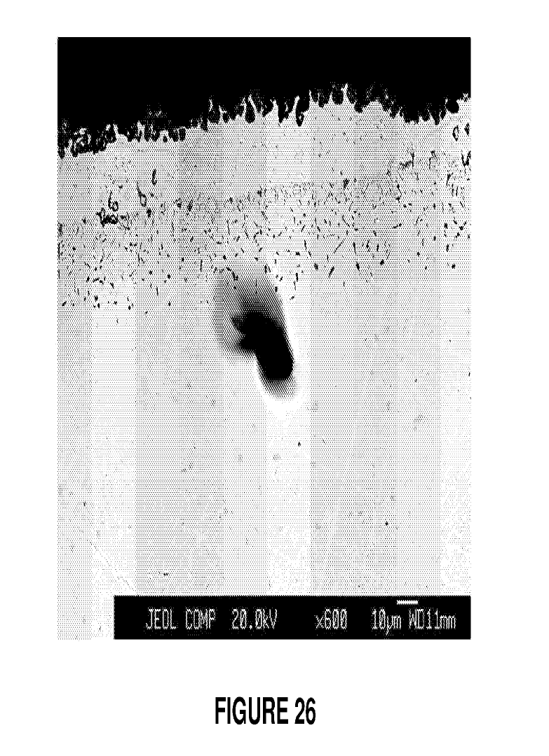

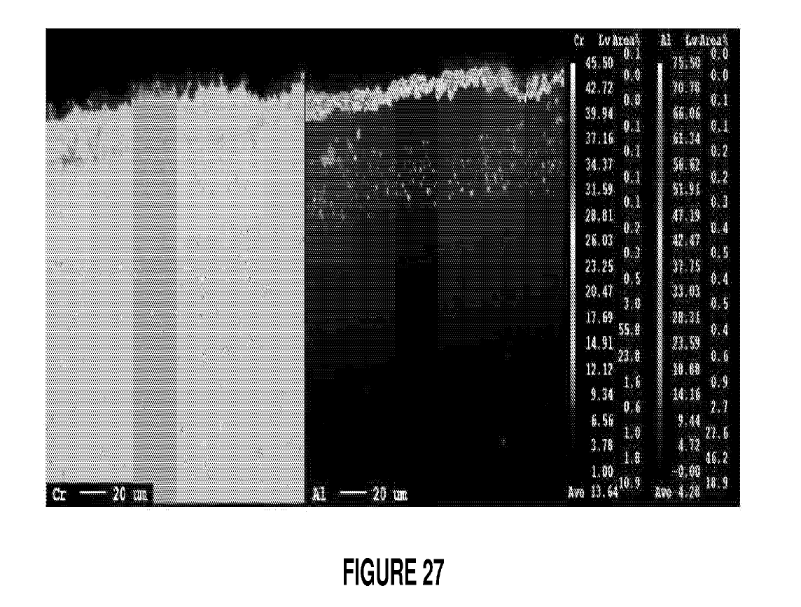

During diffusion heat treatment, no delamination at the Al/steel interface occurred. FIG. 25 compares the surface of Al clad 430 SS (right side) to that of E-Brite with Ni and Al plating (left side) after diffusion treatment followed by oxidation. Delamination was observed with E-Brite. The presence of needle shaped precipitates in the inter-diffusion zone of Al clad 430 SS was also observed (FIG. 26). These precipitates are most likely AlN phase similar to what was also identified in case of pack aluminized 446 SS substrate (FIG. 8). X ray mapping revealed the presence of Al₂O₃ and Cr₂O₃ on the surface layer (FIG. 27). No detailed phase analysis of the coating layers was performed for Al clad 430 SS after diffusion and oxidation treatment.

### II. Chromium Volatilization Tests

After initial evaluation of microstructures, a few types of coatings were tested for their effectiveness as barrier to the Cr volatilization. Diffusion coated coupons were oxidized at 800° C. for 48 hours before the Cr volatilization test in order to stabilize their microstructures and help formation of alumina layer, if any, on the top surface.

The apparatus used for measurement of the chromium volatilization rate was set up according to the transpiration method followed by Gindorf, Singheister and Hilpert (Chromium vaporization from Fe—Cr base alloys used as interconnect in fuel cell, Steel Research, 72 (2001), No 11+12, pp. 528-533). The carrier gas used for this experiment was commercial air from a cylinder passing through a flow rate controller and humidifier set to a dew point of 17.5° C. This dew point setting would load the air with water vapor equivalent to pH₂O=0.02 atmosphere (relative humidity (RH) 60% at room temperature). The chromium volatilization rate was determined in the regime where it is independent of the flow rate of the carrier gas, defined as the “non-equilibrium” regime by Gindorf et al. The test conditions were the following:

### Temperature: 700, 750 and 800° C.

pH₂O: 0.02 atmosphere
Flow rate: 4 SLPM
Duration: 48 hours

The quantity of Cr volatilized from the coupons was determined using the ICPMS technique. The Cr volatilization rates for different coatings investigated are shown in Table 5. From the Cr volatilization data, it is apparent that VPA aluminized E-Brite would be a very effective barrier to Cr volatilization. Specifically the chromium retention rate for NiAI (VPA) and FeAl (VPA) was in excess of 95%.

TABLE 5
Chromium Volatilization Rate for Different Coatings
Cr Volatilization Test Data (pH20 = 0.02 atm)

| | | | | Cr Vol Rate | | |
|---|---|---|---|---|---|---|
| Alloy | Condition | Time (h) | Temp (deg C.) | (Kg/m2/s) | Cr Ret (%) | Remarks |
| 446 | Bare | 48 | 700 | 8.41927E−11 | | |
| 446 | Al2O3 coated | 48 | 700 | 3.63305E−12 | 95.68 | 5 mil thick |
| 446 | Bare | 48 | 750 | 2.72726E−10 | | |
| 446 | Al2O3 coated | 48 | 750 | 1.04107E−11 | 96.18 | 5 mil thick |
| 446 | Bare | 48 | 800 | 4.01078E−10 | | |
| 446 | Al2O3 coated | 48 | 800 | 6.33643E−11 | 84.2 | 5 mil thick |
| 446 | PSZ Coating | 48 | 750 | 8.00942E−11 | 70.63 | 5 mil thick |
| 446 | PSS Coating | 48 | 750 | 7.61024E−12 | 97.21 | 5 mil thick |
| 446 | PSS Coating 10 TC | 48 | 750 | 4.40430E−11 | 85.18 | 5 mil thick |
| 446 | PSS Coating 30 TC | 48 | 750 | 6.22697E−11 | 77.17 | 5 mil thick |
| 446 | PSS Coating 50 TC | 48 | 750 | 7.12660E−11 | 73.87 | 5 mil thick |
| 446 | PSS Coating 1500 h aged | 48 | 750 | 3.46452E−11 | 87.3 | 5 mil thick and |
| | | | | | | 1500 h aged |
| Ebrite | Bare | 48 | 750 | 1.94605E−10 | | |
| Ebrite | NiAl (Slurry coating) I | 48 | 750 | 1.51994E−11 | 92.19 | SermAlcote 2500 - |
| | | | | | | oxidized |
| Ebrite | NiAl (VPA) | 48 | 750 | 4.72571E−12 | 97.57 | VPA coating - |
| | | | | | | oxidized |
| Ebrite | FeAl (VPA) | 48 | 750 | 9.63688E−12 | 95.05 | VPA coating - |
| | | | | | | oxidized |
| Ebrite | NiAl (Slurry coating) II | 48 | 750 | 2.30541E−11 | 88.15 | SennAlcote 2500 - |
| | | | | | | oxidized |

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An article comprising a barrier layer, wherein the barrier layer comprises nickel aluminide, iron aluminide, or a combination thereof, wherein the barrier layer is produced by a diffusion coating process on at least one surface of the article.

2. The article of claim 1, wherein the component comprises iron base alloy, nickel base alloy, or super alloy.

3. The article of claim 1, wherein the nickel aluminide, iron aluminide, or a combination thereof is present up to 150 μm from the surface of the article.

4. The article of claim 1, wherein the diffusion coating process comprises aluminizing at least one surface of the article to produce nickel aluminide, iron aluminide, or a combination thereof.

5. The article of claim 4, wherein the aluminizing step is performed by pack aluminizing, slurry aluminizing, out of pack aluminizing, or CVD aluminizing.

6. The article of claim 4, wherein prior to the aluminizing step, at least one surface of the article is coated with nickel.

7. The article of claim 6, wherein the nickel layer has a thickness of less than 50 μm.

8. The article of claim 4, wherein after the aluminizing step, the article is heated from 800° C. to 1,200° C. for 2 to 8 hours.

9. The article of claim 1, wherein the diffusion coating process comprises (a) CVD aluminizing the surface of stainless steel, and (b) heating the article from 800° C. to 1,200° C. for 2 to 8 hours.

10. The article of claim 1, wherein the article is produced by (a) CVD aluminizing the surface of stainless steel, wherein a prior to the aluminizing step, a layer of nickel was applied to at least one surface of the stainless steel, and (b) is heating the article from 800° C. to 1,200° C. for 2 to 8 hours in the absence of air.

11. The article of claim 1, wherein the diffusion coating process comprises
(a) pressure bonding aluminum foil on at least one surface of the article; and
(b) heating the article for a sufficient time and temperature to produce a metal aluminide layer on the at least one surface of the article.

12. The article of claim 11, wherein the aluminum foil has a thickness of 2 to 40 μm.

13. The article of claim 11, wherein the heating step comprises heating the article from 700° C. to 1,200° C. for 1 to 8 hours.

14. The article of claim 11, wherein the article comprises stainless steel.

15. The article of claim 11, wherein prior to step (a) applying a layer of nickel foil to the least one surface of the component.

16. The article of claim 15, wherein the nickel foil has a thickness of 3 μm to 15 p.m.

17. The article of claim 1, wherein the diffusion coating process comprises
(a) applying a layer of nickel foil to two surfaces of the component to produce two nickel layers each having an exposed surface;
(b) pressure bonding aluminum foil on each exposed surface of each nickel layer; and
(c) heating the article for a sufficient time and temperature to produce a metal aluminide layer on the two surfaces.

18. The article of claim 1, wherein the diffusion coating process comprises
(a) electroplating nickel on at least one surface of the article to produce a nickel layer;
(b) electroplating aluminum on the nickel layer to produce an aluminum layer; and
(c) heating the article for a sufficient time and temperature to produce a metal aluminide layer.

19. The article of claim 18, wherein the nickel layer has a thickness from 0.5 to 5 μm and the aluminum layer has a thickness from 5 to 30 p.m.

20. The article of claim 19, wherein the heating step (c) is from 700° C. to 1,200° C. for 1 to 8 hours.

21. The article of claim 1, wherein the article comprises a metal component present in a fuel cell.

22. The article of claim 20, wherein the metal component comprises a frame for securing an electrode to the fuel cell, a gas inlet tube, or a metal casing.

23. A method for applying a barrier layer to at least one surface of an article comprising diffusion coating nickel aluminide, iron aluminide, or a combination thereof on the at least one surface of the article.

24. A method for preventing or reducing the migration of a metal species present in an article at or near at least one surface of the article comprising applying a barrier layer to the at least one surface of the article, wherein the barrier layer comprises nickel aluminide, iron aluminide, or a combination thereof, wherein the barrier layer is produced by a diffusion coating process on at least one surface of the article.

25. The method of claim 24, wherein the metal species comprises chromium.
